(19) United States
(12) Patent Application Publication
(10) Pub. No.: US 2011/0048847 A1
(43) Pub. Date: Mar. 3, 2011

(54) NOISE ATTENUATION DEVICE FOR REDUCING NOISE ATTENUATION IN A JET ENGINE TEST CELL

(75) Inventors: Norman L. Helgeson, Pacific Palisades, CA (US); Steven Fann, West Hills, CA (US)

(73) Assignee: United States of America as represented by the Secretary of the Navy

(21) Appl. No.: 12/565,895

(22) Filed: Sep. 24, 2009

Related U.S. Application Data
(63) Continuation-in-part of application No. 12/552,771, filed on Sep. 2, 2009.

(51) Int. Cl. F01N 1/14; F02K 1/00

(52) U.S. Cl. 181/220; 181/296

(57) ABSTRACT

A noise attenuation device for use in a jet engine test cell for testing a jet engine comprising a carbon steel pipe which is aligned axially with direction of exhaust from the jet engine. The carbon steel pipe is positioned within an augmenter within the test cell. Cold air enters the front end of the carbon-steel pipe. Adding three times the mass of cold air to that of the hot jet exhaust allows the hot jet exhaust to mix with the cold air forming an engine exhaust-cool air mixture. When the engine exhaust-cool air mixture reaches the outlet end of the carbon steel pipe, its temperature is reduced from 3800° F. to less than 1200° F., which substantially reduces noise generated by the jet exhaust. Located in proximity to the rear end of the carbon steel pipe is an annular region which is formed between perforated side plates within the carbon steel pipe and the inner wall of the augmenter. The flow is diffused as the flow area expands in the annular region. The combination of the carbon steel pipe and the annular region slow the velocity of the jet engine exhaust-cool air mixture, further reducing noise production from the jet engine.

This application is a continuation-in-part application of U.S. patent application Ser. No. 12/552,771, filed Sep. 2, 2009.

### BACKGROUND OF THE INVENTION

1. Field of the Invention

The present invention relates generally to the testing of jet engines. More particularly, the present invention relates to testing a jet engine in a jet engine test cell while substantially attenuating the noise caused by testing the jet engine.

2. Description of the Prior Art

Noise from jet engine testing can cause auditory health effect including hearing loss and deafness, as well as non-auditory health effects such hypertension and nervous disorders. This type of noise also disturbs sleep of individuals in proximity to the test site; affects the performance of children in school and decreases the value of real estate surrounding the test site. In addition, noise from jet engine testing is one of the most common sources of tensions between surrounding communities and miliary air bases, and the military needs to aggressively pursue any and all available means to reduce its impact.

Typical sound levels for noise varies from 60 dBA for normal conversation to 70 dBA for vacuum cleaner to 130 dBA or more for a jet engine at 100 feet. OSHA (Occupational Safety and Health Administration) regulations require that engineering controls be used or that personal protective equipment be provided for a worker exposed to sound levels greater than 85 dBA for more than 8 hours.

As military aircraft engines become more powerful and noisier, as aircraft operations expand, and as land areas proximate to military operational bases are developed for commercial and residential use, jet engine testing noise and other issues create substantial disagreement and tension between the military and local officials.

Thus, there is an urgent need to significantly reduce jet engine noise by up to 20 dBA during static testing of a jet engine in a jet engine test cell. There is also a need to provide the military with a new state of the art device for testing jet engines in a jet engine test cell which is relatively inexpensive and also brings jet engine ground noise limits within acceptable limits to surrounding communities.

### SUMMARY OF THE INVENTION

The present invention overcomes some of the difficulties of the past, including those mentioned above, in that it comprises a relatively simple design and is a highly effective device for testing jet engines in a jet engine test cell. The noise attenuation device comprising the present invention reduces the noise level of the jet exhaust from the engine under static testing to a level acceptable for surrounding environments.

The noise attenuation device of the present invention comprises an empty carbon steel pipe of predetermined length and diameter placed within a jet engine test cell which is a building like structure used to test jet engines. The jet engine under test is also positioned within the test cell in proximity to the front end portion of the carbon steel pipe. The carbon steel pipe is aligned axially with the direction of exhaust flow from the exhaust port of the jet engine being tested. The carbon steel pipe includes flow restrictors downstream from the entrance of front end of the carbon steel pipe. The function of a flow restrictor within the carbon steel pipe is to gradually slow the jet engine exhaust as the jet engine exhaust travels through the carbon steel pipe. Gradually slowing jet engine exhaust flow reduces frictional flow losses and allow recovery of pressure head from the jet engine exhaust flow. Recovering pressure head assist in maintaining high augmentation flow rates through the noise attenuation device and the jet engine test cell.

Located at the rear end of the carbon steel pipe is an exhaust blockage structure which functions as a flow restrictor. The blockage structure used in the noise attenuation device may be either a full blockage cone or a partial blockage cone with openings. In addition, the exhaust blockage structure may be a grill end piece attached to the rear end of the carbon steel pipe.

The cross sectional flow area in the rear portion of the carbon steel pipe increases for a jet engine exhaust-cool air mixture passing through the rear portion of the carbon steel pipe to more than double. A substantial portion of the flow of the jet engine exhaust-cool air mixture is then forced through openings within perforated side walls located in the rear end portion of the carbon-steel pipe.

Cold air enters the front end of the carbon-steel pipe at a temperature of approximately 70 degrees Fahrenheit and has a mass of approximately three times the mass of the hot jet engine exhaust. By adding three times the mass of cold air to that of the hot jet engine exhaust, the hot jet exhaust becomes intimately mixed with the cold air forming the jet engine exhaust-cool air mixture which flows through the carbon steel pipe to the outlet end of the carbon steel pipe. When the jet engine exhaust-cool air mixture from a jet engine operating at after-burner conditions reaches the outlet end of the carbon steel pipe its temperature is reduced from 3800° F. to less than 1200° F., the design limit required to protect the noise attenuation device.

Adding the cold air mass to the jet engine exhaust reduces the average velocity of the resulting mixture stream by a factor of about four. Reducing the velocity of the jet engine exhaust flow reduces the intensity of turbulent fluctuations and the acoustic power produced by the jet engine exhaust plume.

An annular region through which the exhaust-cool air mixtures flows is formed between the side plates and the inner wall of an augmenter within the jet engine test cell. The gas flow pattern of the exhaust-cool air mixture is maintained in a forward direction within the annular region by air flow inducted into the entrance or front end of the noise attenuation device and the augmenter of the jet engine test cell.

The annular region formed between the side plates and the inner wall of the augmenter provides greater flow area, slowing the velocity of the jet engine exhaust-cool air mixture and reducing the power of noise produced by the jet engine.

### BRIEF DESCRIPTION OF THE DRAWINGS

FIG. 1 is a view in perspective of the noise attenuation device for testing jet engines comprising a preferred embodiment of the present invention;

FIG. 2 is an end view of the noise attenuation device of FIG. 1 without a flow deflector;

FIG. 3 is an end view of the noise attenuation device of FIG. 1 with a flow deflector;

FIGS. 4A and 4B depict the gas flow pattern of the jet engine exhaust plume within the noise attenuation device of FIG. 1; and

FIG. 5 is a schematic diagram which illustrates the positioning of the noise attenuation device of FIG. 1 within a jet engine test cell which is used to conduct static testing of a jet engine;

FIG. 6 is an enlarged view of the noise attenuation device positioned with augmenter of the jet engine test cell; and

FIG. 7 is an illustration of the grill end piece attached to the rear end of the carbon steel pipe to limit jet engine exhaust flow through the rear end of the carbon steel pipe when the noise attenuation device is within the jet engine test cell.

### DETAILED DESCRIPTION OF A PREFERRED EMBODIMENT

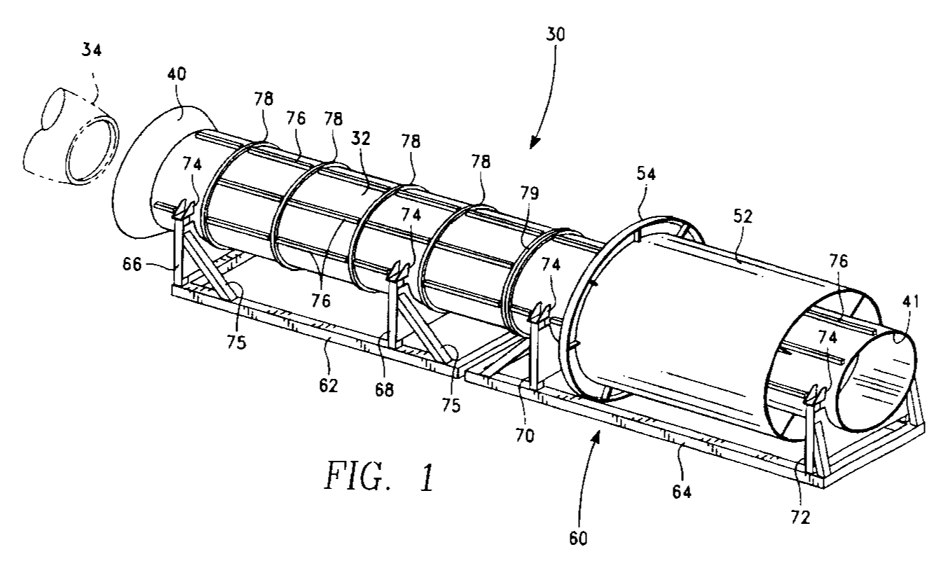

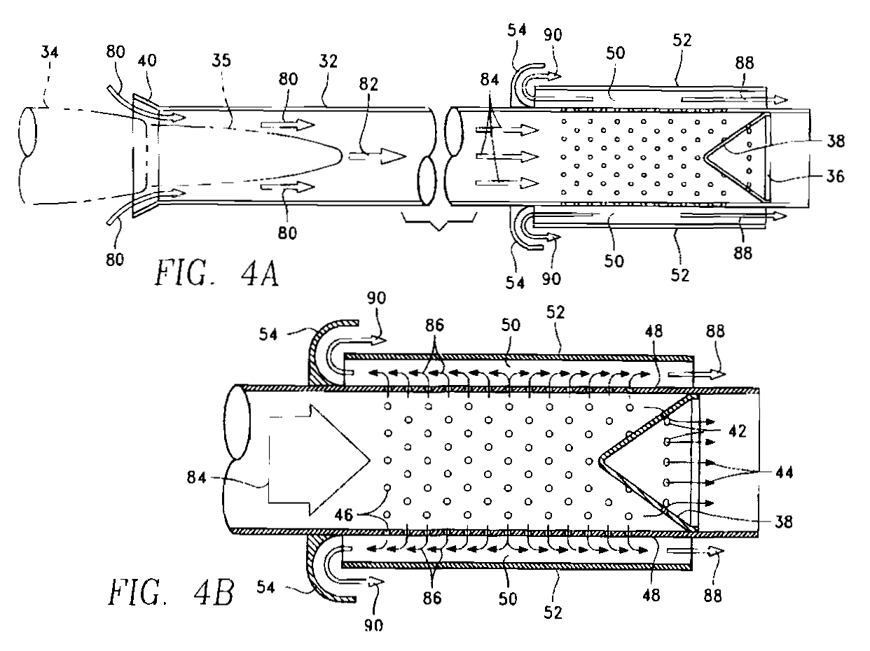

Referring to FIGS. 1, 4A and 4B, the full scale cylindrical-shaped noise attenuation device 30, which is 51 feet in length, has a diameter of 6 to 14 feet, weighs approximately 25 tons, and is fabricated from empty sections of carbon-steel pipe 32. The carbon-steel tube 32 has an inside diameter of approximately 6 feet and is formed of ½ inch thick carbon-steel plate.

Noise attenuation device 30 incorporates fluid dynamic control elements to catch, slow and deflect the jet engine exhaust plume 35 from a jet engine 34. The carbon-steel tube 32 is aligned axially with the direction of jet engine exhaust flow from the exhaust port of a jet engine 34 under going a static performance test.

The slowing of the jet engine exhaust plume 35 from jet engine 34 operates to reduce the intensity of otherwise persistent noise-generating turbulent eddies from the jet, thereby reducing the noise produced by the static testing of the jet engine 34.

As is best seen in FIG. 1, the noise attenuation device is mounted on a test support structure 60. The test support structure 60 has a rectangular shaped base 62 in the forward portion of the structure 60 and another rectangular shaped base 64 in the rear portion of the structure 60. Supporting two sections of the noise attenuation device 30 joined to each other by a connection flange 79, base 62 of test support structure 60 includes a pair of vertically orientated support cradles 66 and 68 which are located near the front and rear end of base 62. Base 64 of test support structure 60 also includes a pair of vertically orientated support cradles 70 and 72 which are located near the front and rear end of base 64. The two sections of the empty carbon-steel pipe 32 of noise attenuation device 30 rest on the cradles 66, 68, 70 and 72 of test support structure 60 in the manner illustrated in FIG. 1. Angled support members 75, angled at approximately forty five degrees, are provided for each of the cradles 66, 68, 70 and 72 to insure stability of the cradles 66, 68, 70 and 72 during the static testing of a jet engine. Each cradle 66, 68, 70 and 72 also has a pair of clamping devices 74 which secure carbon-steel pipe 32 to each cradle 66, 68, 70 and 72 of the test structure 60. The centerline of the carbon-steel tube 32 is positioned approximately 5′-2″ above the ground when the carbon-steel tube 32 is portioned on the support structure 60 in the manner shown in FIG. 1.

Referring again to FIGS. 1, 4A and 4B, FIGS. 4A and 4B shows the gas flow field through the noise attenuation device 30. The technical objective of the noise attenuation device 30 (as shown in FIGS. 4A and 4B) is to ensure a safe and acceptable flow of the jet exhaust plume 35 through the interior of the noise attenuation device 30 and to reach acceptable noise reduction levels. To meet this technical objective, the noise attenuation device 30 is designed to: (1) slow jet exhaust by mixing jet engine exhaust with entrained air (momentum exchange); (2) cool exhaust at 3800° F. with a 3:1 ratio of entrained air (thermal mixing); and (3) convert velocity head to pressure head for changing flow directions within the noise attenuation device 30, shroud 52 and flow deflector 54.

The exhaust of the jet engine 34 under test is positioned near the front end portion 40 of the carbon-steel pipe 32 of device 30. As seen in FIG. 4A, the front end portion 40 of carbon-steel pipe 32 is angled outward to provide for adequate air flow of cold air from the atmosphere. It should be noted the diameter of the angled front end portion 40 of device 30 is 7 feet 10⅞ inches at its maximum width.

The cold air 80 entering the carbon-steel pipe 32 (represented by arrows 80) is at a temperature of approximately 70 degrees Fahrenheit and has a mass of approximately three times the mass of the hot jet engine exhaust (represented by arrow 82). By adding three times the mass of cold air 80 to that of the hot jet exhaust which reaches 3800° F., the hot jet exhaust becomes intimately mixed (as represented by arrows 84) with the cold air forming a jet engine exhaust-cool air mixture 84.

The length and diameter of the noise attenuation device 30 are sized to accommodate the gas mixing and cooling process within the carbon-steel pipe 32 (approximately 51 feet in length and a pipe radius of approximately of 3 feet 9 5/16 inches). When the hot jet engine exhaust-cool air mixture 84 reaches the outlet end 41 of pipe 32, its temperature is reduced to less than 1200° F. which is the design limit set to protect the noise attenuation device 30 structural elements from over-heating during the short time periods of engine operation at after-burner power.

To ensure adequate slowing of the exhaust plume 35 from the jet engine 24 being tested, the outlet end 36 of pipe 32 of the noise attenuation device 30 is blocked or partially blocked by a blockage cone 38. The blockage cone 38 used in the noise attenuation device 30 may be either a full blockage cone or a partial blockage cone with openings. The blockage cone 38 illustrated in FIG. 4B includes a plurality of openings 42 which allow a portion of the jet exhaust-cool air mixture to exit the outlet end 36 of the noise attenuation device 30 through partial blockage cone 38 (in the manner illustrated by arrows 44). Depending upon the type of engine currently being tested, the blockage cone 38 will either include or exclude the openings 42. For example, when a Pratt and Whitney J-52 turbojet engine is being tested a full blockage cone is used for the test. Similarly, when a General Electric F-404 engine is being tested a partial blockage cone of the type illustrated in FIG. 4B is used for the test.

Referring to FIG. 4B, FIG. 4B shows that the flow of the exhaust plume 35 does not have a clear shot at proceeding through the noise attenuation device 30 without significant slowing of the jet engine exhaust. The cross sectional flow area for the jet engine exhaust is more than doubled as a substantial portion of the flow of the jet engine exhaust-cool air mixture 84 is forced through openings 46 (FIG. 4B) within perforated side plates/walls 48 located in the rear portion of the carbon-steel pipe 32. Arrows 86 indicate the flow pattern of the jet engine exhaust through the openings 46 within side walls 48 into an annular gas flow region 50 surrounding the rear end portion of carbon-steel pipe 32.

As seen in FIGS. 4A and 4B, the side plates 48 and shroud 52 which surrounds the rear end portion of the carbon-steel pipe 32 forms an annular region through which exhaust flows. Also as seen in FIGS. 4A and 4B, the gas flow pattern is in both a forward direction and a rearward direction which is indicated by arrows 88 and 90. A flow deflector 54 attached to the carbon-steel pipe 32 is positioned at the front end of shroud 52. The flow deflector 54 forces jet engine exhaust exiting the forward end of shroud 52 to reverse direction and flow in the same direction as jet engine exhaust exiting the rear end of shroud 52.

Thus, it can be seen that a portion of the jet engine exhaust is forced to change flow direction twice before exiting noise attenuation device 30 (in the manner indicted by arrows 90). Changing flow direction requires pressure differentials and the required pressure head is obtained from that of the high velocity jet engine exhaust.

With respect to the noise attenuation device 30, pressure is recovered by a diffuser effect. The pressure head recovered is used to turn and maintain the flow of engine exhaust through the perforated side walls 48 and turn the engine exhaust back again to an axial direction in the annular region 50 of noise attenuation device 30. This slows the flow of the exhaust, reducing the power of noise producing flow turbulence and functions as a shroud for the major noise producing regions of the jet engine 34.

In the preferred embodiment, the perforated side walls 48 are located approximately 35 feet from the front end portion 40 of the carbon-steel pipe 32.

Intensity of noise produced by a jet is highly dependent on the velocity of the jet. At the high velocities characteristic of military jet engine exhausts (2000-4500 ft/second), the conversion of kinetic flow energy to acoustic noise dramatically increases with velocity. Noise attenuation device 30 reduces velocity by capturing the exhaust plume 35 in a tunnel formed within the interior of carbon steel pipe 32 and mixing the jet engine exhaust 82 in a confined region (interior of the carbon steel pipe 32) with approximately three times the mass of cold air as the quantity of jet engine exhaust 82 flow. Adding the cold air mass (represented by arrow 80) to the jet engine exhaust 82 reduces the average velocity of the resulting mixture stream (represented by arrows 84) by a factor of about four. By reducing the velocity of the jet engine exhaust flow the intensity of turbulent fluctuations is reduced and the acoustic power emitted by the jet engine 34 is also dramatically reduced.

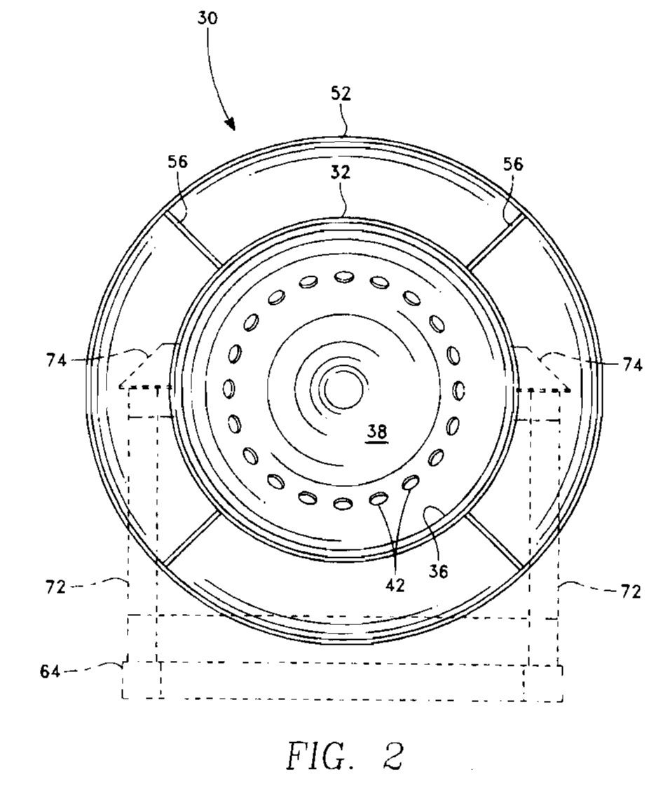

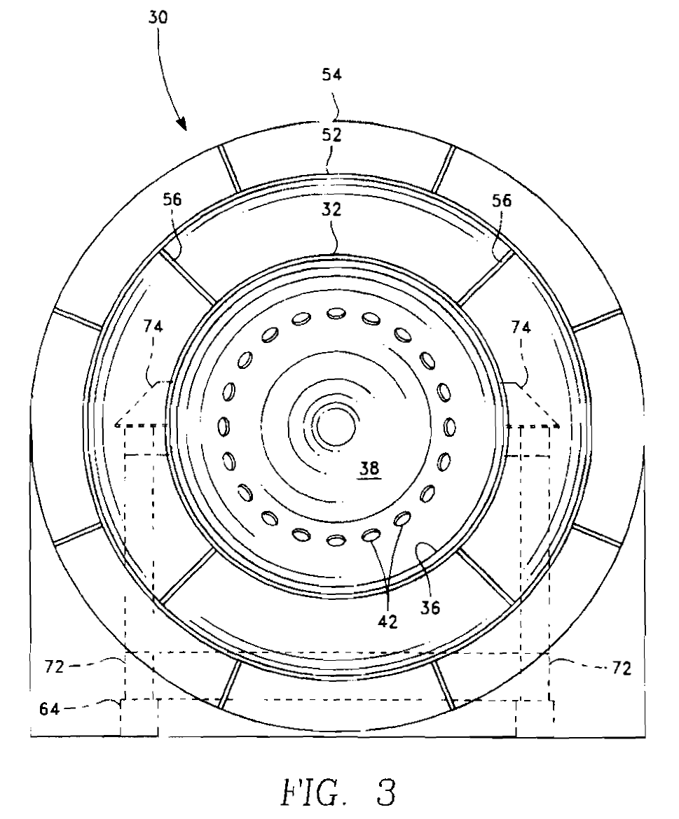

Referring to FIGS. 2 and 3, noise attenuation device 30 is depicted in FIG. 2 with the shroud 52 which surrounds the rear end portion of the carbon-steel pipe 32. Shroud 52 is attached to the carbon-steel pipe 32 by four equally spaced ½″ thick support plates/fins 56. The support fins 56 are attached to the outer surface of the carbon steel pipe 32 and the inner surface of the shroud 52 by welds (not shown). Utilizing the support fins 56 in the manner illustrated in FIG. 2 allows for substantially unrestricted jet engine exhaust flow within the annular gas flow region 50 (as shown in FIG. 42).

FIG. 3 depicts the noise attenuation device 30 with the shroud 52 which surrounds the rear end portion of the carbon-steel pipe 32 and the flow deflector 54 which is attached to the carbon-steel pipe 32 and is positioned at the front end of the shroud 52. Also shown in FIGS. 2 and 3 in phantom is one of the cradles 72 and its associated clamps 74.

Field testing of the noise attenuation device 30 and the flow deflector 54 with the Lockheed F-404 engine were completed for engine power levels up to and including after-burner, proving the adequacy and operation of the flow deflector 54 for use in noise attenuation during the static testing of a jet engine. Noise measurements were recorded at five engine power levels. These measurements showed increasing noise reductions with increasing engine power in both near field and far field locations reaching total noise reductions greater than 20 dBA at after burner conditions for both locations.

Near field measurements were made at approximately ninety feet from the noise attenuation device and the jet engine under test. Far field measurements were taken at approximately two miles from the noise attenuation device and the jet engine under test. The insertion loss for the near field measurements reached a maximum of 20.6 dBA at maximum after-burner. Testing without noise attenuation device 30 resulted in a noise level of 138 dBA while testing with noise attenuation device 30 resulted in a noise level of 117.4 dBA, with the difference being 20.6 dBA at maximum after-burner. The insertion loss for the far field measurements reached a maximum of 34.3 dBA at maximum after-burner. Testing without noise attenuation device 30 resulted in a noise level of 74.1 dBA while testing with noise attenuation device 30 resulted in a noise level of 39.8 dBA, with the difference being 34.3 dBA at maximum after-burner.

Noise attenuation device 30 was constructed of carbon steel with an upper service temperature of approximately 1200° F. while noise attenuation device 30 is designed to be subjected to an operating environment for testing the General Electric F-414 jet engine at after burner conditions of 3900° F. Noise attenuation device 30 is not exposed to these extreme temperature conditions for long periods of time, but exposure times of even a few minutes at after burner temperature conditions would cause rapid degradation of the carbon steel pipe 32. To address this concern, sufficient air (approximately 3:1 mass ratio) s needed to be entrained into the noise attenuation device 30 to provide an jet engine exhaust gas/cool air mixture which, when fully mixed, will have an average temperature that does not exceed 1200° F.

Further, the noise attenuation device structure to prevent structural resonance problems caused by the intense vibrational testing of the jet engine. The design of the noise attenuation device structure includes (a) longitudinal segments of the main body of noise attenuation device 30 being broken into uneven lengths to reduce and eliminate full or partial length longitudinal resonant body frequencies, and (b) numerous longitudinal reinforcing bracing bars 76 and circumferential reinforcing bracing bars 78 were added to the structure to reduce and eliminate resonant frequencies that can occur in isolated regions of the structure.

As previously discussed, the carbon-steel pipe 32 has a front end section and a back end section which are attached to each other by a front and back joining flange 79 which is shown in FIG. 1.

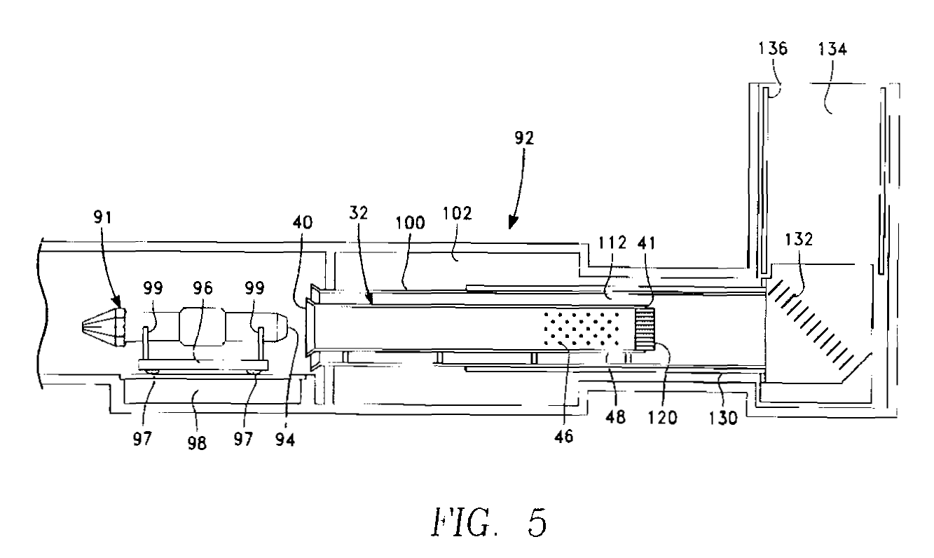

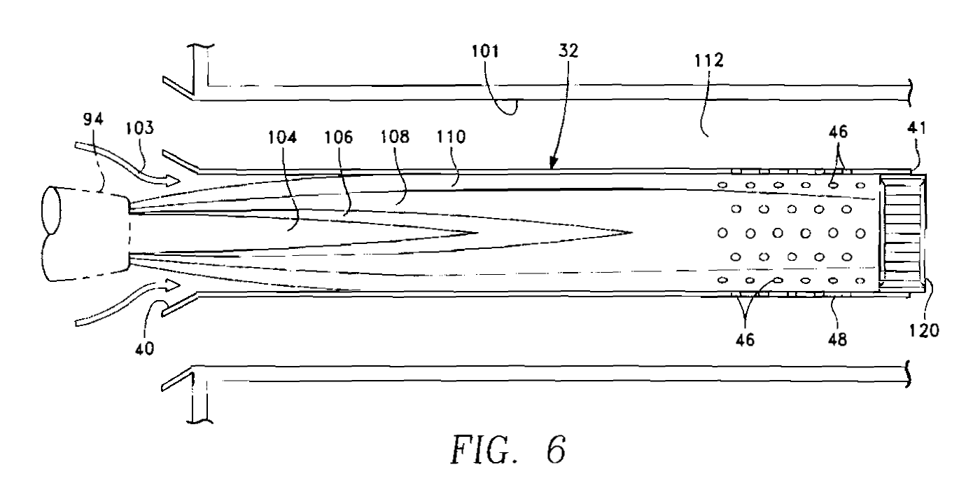

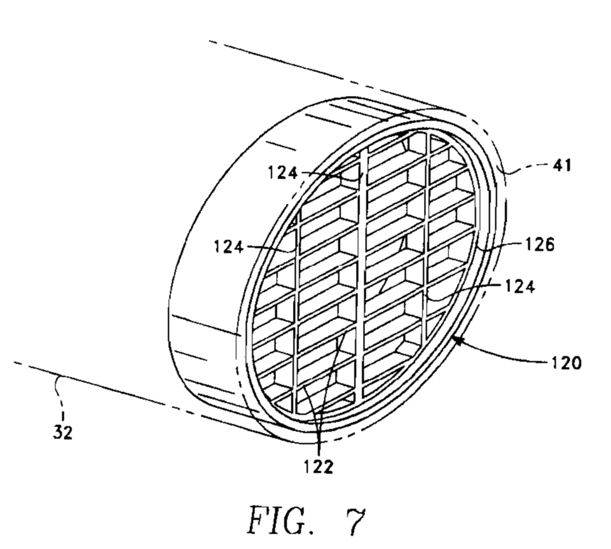

Referring to FIGS. 5 and 6, another embodiment of the present invention for testing a jet engine 91 in a jet engine test cell 92 is depicted in FIG. 5. The jet engine 91 under test is positioned within the test cell in proximity to the front end portion 40 of the carbon steel pipe 32. The carbon steel pipe 32 is aligned axially with the direction of exhaust flow from the exhaust port 94 of the jet engine 91 being tested. The carbon steel pipe 32 includes flow restrictors downstream (e.g. grill end piece 120, FIG. 7) from the entrance of front end 40 of the carbon steel pipe 32. The function of a flow restrictor, such as grill end piece 120, within the carbon steel pipe 32 is to cause slowing of the jet engine exhaust as the jet engine exhaust travels through the carbon steel pipe 32. Slowing the jet engine exhaust flow reduces frictional flow losses and allows recovery of pressure head from the jet engine exhaust flow. Recovering pressure head assist in maintaining high augmentation flow rates through the noise attenuation device and the jet engine test cell 92.

The jet engine 91 under going static testing within the test cell 92 rests on a portable jet engine holding rack 96 that has wheels 97 and a pair of cradles 99. The cradle 99 is locked into place to prevent forward movement of the jet engine 91 caused by the thrust generated by the jet engine 91. The jet engine 91 rests upon the cradles 99 during static testing of the jet engine within the jet engine test cell 92. The jet engine 91 being tested is located above an oil catch 98 which traps oil and other contaminants from the jet engine 91 being tested.

As shown in FIG. 5 the carbon steel pipe 32 of noise attenuation device 30 is positioned within an augmenter 100 which is located in the detuner room 102 of jet engine test cell 92. The augmenter 100 of test cell 92 has a diameter of approximately 15 feet 6 inches at its front end and an overall length of approximately 82 feet which is sufficiently large to allow positioning of the carbon steel tube 32 of noise attenuation device 30 within the interior of augmenter 100.

Cold air enters the front end 40 of the carbon-steel pipe 32 at a temperature of approximately 70 degrees Fahrenheit and has a mass of approximately three times the mass of the hot jet engine exhaust 104 from the exhaust port 94 of the jet engine 91 under going static testing. By adding three times the mass of cold air to that of the hot jet engine exhaust 104, the hot jet exhaust 104 becomes intimately mixed with the cold air 103 forming the jet engine exhaust-cool air mixture 110 which flows through the carbon steel pipe to the outlet end 41 of the carbon steel pipe 32. When the jet engine exhaust-cool air mixture 110 from a jet engine 91 operating at after-burner conditions reaches the outlet end of the carbon steel pipe its temperature is reduced from 3800° F. (jet engine exhaust 104) to less than 1200° F. (exhaust-cool air mixture 110), the design limit required to protect the noise attenuation device.

The effective cross sectional flow area in the rear end portion 41 of the carbon steel pipe 32 increases several times for the jet engine exhaust-cool air mixture 110 (FIG. 6) as flow passes through the rear end portion 41 of the carbon steel pipe 32 and expands into an adjoining augmenter space 112. A majority of the flow of the jet engine exhaust-cool air mixture 110 passes through openings 46 within perforated side plates/walls 48 located in the rear end portion 41 of the carbon-steel pipe 32.

It should be noted that as shown in FIG. 6 the reference numeral 106 represents the jet engine hot exhaust from the exhaust port 94 of the jet engine 91 undergoing static testing. The reference numeral 103 identifies the cold air mass entering the front end 40 of the carbon steel pipe 32 and reference numeral 103 also represents cold air entering the annular space 112 enclosed by the carbon steel pipe 32 and augmenter 100 of jet engine test cell 92.

Reference numeral 110 represents the jet engine exhaust-cool air mixture flowing through the carbon steel pipe 32. The reference numerals 106 and 108 represent the jet engine exhaust temperatures and velocity within the interior of the carbon steel pipe 32 as the cold air mass 103 mixes with the jet engine exhaust 104. The jet engine exhaust-cool air mixture 110 then exits the carbon steel pipe 32 through openings 46 and the grill end piece 120 located at the outlet end 41 of carbon steel pipe 32.

Adding the cold air mass to the jet engine exhaust 104 reduces the average velocity of the resulting mixture stream 110 by a factor of about four. Reducing the velocity of the jet engine exhaust 104 flow reduces the intensity of turbulent fluctuations and the acoustic power produced by the jet engine exhaust plume.

An annular region 112 through which the jet engine exhaust-cool air mixtures flows is formed between the side plates 48 and the inner wall 101 of augmenter 100 located within the jet engine test cell 92. The gas flow pattern of the exhaust-cool air mixture 110 is maintained in a forward direction within the annular region 112 by air flow inducted into the entrance or front end 40 of the noise attenuation device 30 and the jet engine exhaust-cool air mixture 110 inducted into the augmenter 100 of the jet engine test cell 92.

The annular region 112 formed between the side plates 48 and the inner wall 101 of the augmenter 100 provides greater flow area, further slowing the velocity of the jet engine exhaust-cool air mixture 110 and reducing the power of noise produced by the jet engine.

When the carbon-steel pipe 32 of noise attenuation device 30 is positioned within the augmenter 100 of jet engine test cell 92, neither the shroud 52 or flow deflector 54 are used as components of noise attenuation device 30.

As shown in FIG. 5, the augmenter 100 of jet engine test cell 92 has acoustic lined panels 130 positioned around the rear portion of augmenter 100. The use of acoustic lined panels 103 is optional and depends upon the user's requirements to further reduce jet engine noise generated by a jet engine 91 under going static testing within the jet engine test cell 92.

The acoustic line panels 130 operate as noise attenuation devices o reduce noise levels from the jet engine 91 under going testing within the jet engine test cell 92. The jet engine test cell 92 also has a plurality of turning vanes 132 which direct the jet engine exhaust-cool air mixture 110 upward through a jet engine exhaust stack 134 located at the end of the jet engine test cell 92. The jet engine exhaust stack 134 also has acoustic lining insulation to further reduce noise generated by the jet engine exhaust.

Referring to FIG. 7, there is shown a grill end piece 120 attached to the rear end 41 of the carbon steel pipe 32. The grill end piece 120 is designed to limit jet engine exhaust flow through the rear end 41 of the carbon steel pipe 32 when the noise attenuation device 32 is positioned within the jet engine test cell 92. The grill end piece 120, for example, may include a plurality of equally spaced apart horizontal grill members 122, a plurality of equally spaced apart vertical grill members 124 and a ring structure which is attached to the rear end 41 of carbon steel pipe 32. The ring structure 126 has the horizontal grill members 122 and vertical grill members 124 attached thereto and also provides support for the horizontal grill members 122 and vertical grill members 124. Further, the horizontal grill members 122 and vertical grill members 124 are interlaced with each other in the manner shown in FIG. 7.

From the foregoing, it may readily be seen that the present invention comprises a new unique and exceedingly useful noise attenuation device for use in testing a jet engine which constitutes a considerable improvement over the known prior art for outdoor testing of jet engines on test stands and in test cells. Many modifications and variations of the present invention are possible in light of the above teachings. It is to be understood that within the scope of the appended claims the invention may be practiced otherwise than as specifically described.

What is claimed is:

1. A noise attenuation device for reducing noise generated by a jet engine under going static testing in a jet engine test cell comprising:
(a) a carbon-steel pipe centrally positioned within an interior of an augmenter which is located in said jet engine test cell, said carbon-steel pipe having a predetermined length and a predetermined diameter, wherein said carbon-steel pipe is aligned axially with the direction of exhaust flow from an exhaust port of said jet engine and said jet engine is located within said jet engine test cell during the static testing of said jet engine;
(b) said carbon-steel pipe having a front end which is angled outward to provide for adequate air flow of cold air from the interior of said jet engine test cell into said carbon-steel pipe, an interior which receives the cold air from said jet engine test cell, and a rear end, the exhaust port of said jet engine being positioned within said jet engine test cell at the front end of said carbon-steel pipe, wherein the cold air enters the front end of said carbon-steel pipe at a temperature of approximately 70 degrees Fahrenheit, and has a mass of approximately three times the mass of hot jet engine exhaust from the exhaust port of said jet engine;
(c) said carbon-steel pipe having an elongated interior adapted to fit within the interior of said augmenter, said carbon-steel pipe receiving the cold air from the interior of said jet engine test cell and the hot jet engine exhaust from the exhaust port of said jet engine and then mixing the hot jet engine exhaust with the cold air forming a jet engine exhaust-cool air mixture;
(d) said carbon-steel pipe having a rear end portion which includes a plurality of perforated side plates, wherein said jet engine exhaust-cool air mixture cools from 3800° F. to less than 1200° F. as said jet engine exhaust-cool air mixture travels through the interior of said carbon-steel pipe;
(e) an annular region which is formed between the perforated side plates of said carbon steel pipe and an inner wall of said augmenter which surrounds the rear end portion of said carbon-steel pipe;
(f) a blockage device positioned at the rear end of the rear end portion of said carbon-steel pipe, wherein said blockage device assists in forcing a substantial portion of the flow of the jet engine exhaust-cool air mixture from the interior of said carbon-steel pipe through openings within said perforated side walls into said annular region; and
(g) said annular region slowing average velocity of the jet engine exhaust-cool air mixture entering the rear end portion of said carbon-steel pipe and substantially reducing noise produced by said jet engine being tested in said jet engine test cell.

2. The noise attenuation device of claim 1 wherein adding cold air mass to the hot jet engine exhaust reduces the average velocity of the jet engine exhaust-cool air mixture by a factor of about four which reduces an intensity of turbulent fluctuations and acoustic power produced by an exhaust plume from a jet engine exhaust plume.

3. The noise attenuation device of claim 1 wherein the predetermined length of said carbon-steel pipe is approximately fifty feet and the predetermined diameter of said carbon-steel pipe is approximately six feet.

4. The noise attenuation device of claim 1 wherein noise reduction levels for said jet engine undergoing said static testing within said jet engine test cell are greater than 20 dBA at after burner conditions.

5. The noise attenuation device of claim 1 wherein said carbon-steel pipe has a front end section and a back end section which are attached to each other by a front and back joining flange.

6. The noise attenuation device of claim 1 further comprising a plurality of longitudinal reinforcing bracing bars and a plurality of circumferential reinforcing bracing bars affixed to the outside surface of said carbon-steel pipe to reduce and eliminate resonant frequencies which may otherwise occur in isolated regions of said noise attenuation device.

7. The noise attenuation device of claim 1 further comprising a test support structure having a first rectangular shaped base in a forward portion of the said test support structure and a second rectangular shaped base in a rear portion of said test support structure, each of said first and second rectangular shaped bases including a pair of vertically orientated support cradles which are located near the front and rear ends of said first and second rectangular shaped bases, wherein two sections of said carbon-steel pipe of said noise attenuation device rest on the support cradles of said first and second rectangular shaped bases.

8. The noise attenuation device of claim 7 wherein each support cradle includes:
(a) a pair of clamping devices which secure said carbon-steel pipe to each support cradle of said first and second rectangular shaped bases; and
(b) a pair of angled support members, angled at approximately forty five degrees, to insure stability of said cradles during the static testing of said jet engine.

9. The noise attenuation device of claim 1 wherein said blockage device for said noise attenuation device is a full blockage device which prevents said jet engine exhaust-cool air mixture from exiting the rear end of said carbon-steel pipe.

10. The noise attenuation device of claim 1 wherein said blockage device for said noise attenuation device comprises a grill end piece attached to the rear end of said carbon steel pipe, said grill end piece operating to limit jet engine exhaust flow through the rear end of said carbon steel pipe when said noise attenuation device is positioned within said jet engine test cell, said grill end piece including a plurality of equally spaced apart horizontal grill members, a plurality of equally spaced apart vertical grill members and a ring structure which is attached to the rear end of said carbon steel pipe, wherein said ring structure has the horizontal grill members and the vertical grill members attached to said ring structure and provides support for said horizontal grill members and said vertical grill members, said horizontal grill members and said vertical grill members being interlaced with one another.

11. A noise attenuation device for reducing noise generated by a jet engine under going static testing in a jet engine test cell comprising:
(a) a carbon-steel pipe centrally positioned within an interior of an augmenter which is located in said jet engine test cell, said carbon-steel pipe having a predetermined length and a predetermined diameter, the predetermined length of said carbon-steel pipe being approximately fifty feet and the predetermined diameter of said carbon-steel pipe being approximately six feet wherein said carbon-steel pipe is aligned axially with the direction of exhaust flow from an exhaust port of said jet engine and said jet engine is located within said jet engine test cell during the static testing of said jet engine;
(b) said carbon-steel pipe having a front end which is angled outward to provide for adequate air flow of cold air into said carbon-steel pipe from the interior of said jet engine test cell into said carbon-steel pipe, an interior which receives the cold air from said jet engine test cell, and a rear end, the exhaust port of said jet engine being positioned within said jet engine test cell at the front end of said carbon-steel pipe, wherein the cold air enters the front end of said carbon-steel pipe at a temperature of approximately 70 degrees Fahrenheit, and has a mass of approximately three times the mass of hot jet engine exhaust from the exhaust port of said jet engine;
(c) said carbon-steel pipe having an elongated interior for receiving the cold air from the atmosphere and the hot jet engine exhaust from said jet engine and then mixing the hot jet engine exhaust with the cold air forming a jet engine exhaust-cool air mixture;
(d) said carbon-steel pipe having a rear end portion which includes a plurality of perforated side plates, wherein said jet engine exhaust-cool air mixture cools from 3800° F. to less than 1200° F. as said jet engine exhaust-cool air mixture travels through the interior of said carbon-steel pipe;
(e) an annular region is formed between said perforated side plates and an inner wall of said augmenter which surrounds the rear end portion of said carbon-steel pipe;
(f) a blockage device positioned at the rear end of the rear end portion of said carbon-steel pipe, wherein said blockage device assists in forcing a substantial portion of the flow of the jet engine exhaust-cool air mixture through openings within said perforated side walls into said annular region;
(g) said annular region slowing average velocity of the jet engine exhaust-cool air mixture and substantially reducing noise produced by said jet engine; and
(h) said blockage device for said noise attenuation device comprises a grill end piece attached to the rear end of said carbon steel pipe, said grill end piece operating to limit jet engine exhaust flow through the rear end of said carbon steel pipe when said noise attenuation device is positioned within said jet engine test cell, said grill end piece including a plurality of equally spaced apart horizontal grill members, a plurality of equally spaced apart vertical grill members and a ring structure which is attached to the rear end of said carbon steel pipe, wherein said ring structure has the horizontal grill members and the vertical grill members attached to said ring structure and provides support for said horizontal grill members and said vertical grill members, said horizontal grill members and said vertical grill members being interlaced with one another; and
(i) said noise attenuation device providing for noise reduction levels for said jet engine undergoing said static testing of at least 20 dBA at after burner conditions.

12. The noise attenuation device of claim 11 wherein adding cold air mass to the hot jet engine exhaust reduces the average velocity of the jet engine exhaust-cool air mixture by a factor of about four which reduces an intensity of turbulent fluctuations and acoustic power produced by an exhaust plume from said jet engine exhaust plume.

13. The noise attenuation device of claim 11 further comprising a plurality of longitudinal reinforcing bracing bars and a plurality of circumferential reinforcing bracing bars affixed to the outside surface of said carbon-steel pipe to reduce and eliminate resonant frequencies which may otherwise occur in isolated regions of said noise attenuation device.

14. The noise attenuation device of claim 11 further comprising a test support structure having a first rectangular shaped base in a forward portion of the said test support structure and a second rectangular shaped base in a rear portion of said test support structure, each of said first and second rectangular shaped bases including a pair of vertically orientated support cradles which are located near the front and rear ends of said first and second rectangular shaped bases, wherein two sections of said carbon-steel pipe of said noise attenuation device rest on the support cradles of said first and second rectangular shaped bases.

15. The noise attenuation device of claim 14 wherein each support cradle includes:
(a) a pair of clamping devices which secure said carbon-steel pipe to each support cradle of said first and second rectangular shaped bases; and
(b) a pair of angled support members, angled at approximately forty five degrees, to insure stability of said cradles during the static testing of said jet engine.

16. A method for reducing noise generated by a jet engine under going static testing comprising the steps of:
(a) providing a carbon-steel pipe centrally positioned within an interior of an augmenter which is located in said jet engine test cell, said carbon-steel pipe having a predetermined length and a predetermined diameter, wherein said carbon-steel pipe is aligned axially with the direction of exhaust flow from the exhaust port of said jet engine and said jet engine is located within said jet engine test cell during the static testing of said jet engine;
(b) positioning the exhaust port of said jet engine at the front end of said carbon-steel pipe, wherein the front end of said carbon-steel pipe is angled outward to allow cold air to flow from the interior of said jet engine test cell into the interior of said carbon-steel pipe;
(c) providing said cold air from the interior of said jet engine test cell through the front end of said carbon-steel pipe to an elongated interior of said carbon-steel pipe at a temperature of approximately 70 degrees Fahrenheit, wherein said cold air entering the interior of said carbon-steel pipe has a mass of approximately three times the mass of hot jet engine exhaust from the exhaust port of said jet engine;
(d) receiving the cold air from said jet engine test cell and the hot jet engine exhaust from said jet engine, wherein the elongated interior of said carbon-steel pipe receives said cold air and said hot jet engine exhaust;
(e) mixing the hot jet engine exhaust with the cold air forming a jet engine exhaust-cool air mixture, wherein mixing the hot jet engine exhaust with the cold air reduces the temperature of said jet engine exhaust-cool air mixture from about 3800° F. to about 1200° F. as said jet engine exhaust-cool air mixture travels through the elongated interior of said carbon-steel pipe;
(f) reducing an average velocity of said jet engine exhaust-cool air mixture by a factor of about four by adding cold air mass to said hot jet engine exhaust, wherein reducing the average velocity of said hot jet engine exhaust reduces an intensity of turbulent fluctuations and acoustic power produced by said hot jet engine exhaust;
(g) providing a plurality of perforated side plates located in a rear end portion of said carbon-steel pipe;
(h) providing a blockage device at a rear end of said carbon-steel pipe;
(i) forming an annular region around the exterior of the rear end portion of said carbon-steel pipe, wherein said annular region is formed between an inner wall of said augmenter and said perforated side plates
(j) forcing a substantial portion of the flow of the jet engine exhaust-cool air mixture through openings within said perforated side walls into said annular region, wherein said blockage device assists in forcing said substantial portion of the flow of said jet engine exhaust-cool air mixture through the openings within said perforated side walls into said annular region; and
(k) slowing the average velocity of the jet engine exhaust-cool air mixture passing through said annular region which substantially reduces noise produced by said jet engine under going static testing.

17. The method of claim 16 wherein the predetermined length of said carbon-steel pipe is approximately fifty feet and the predetermined diameter of said carbon-steel pipe is approximately six feet.

18. The method of claim 16 further comprising the steps of:
(a) providing a plurality of longitudinal reinforcing bracing bars affixed to the outside surface of said carbon-steel pipe; and
(b) providing a plurality of circumferential reinforcing bracing bars affixed to the outside surface of said carbon-steel pipe, wherein said plurality of longitudinal reinforcing bracing bars and said plurality of circumferential reinforcing bracing bars reduce and eliminate resonant frequencies which may otherwise occur in isolated regions of said carbon-steel pipe.

19. The method of claim 16 further comprising the steps of:
(a) providing a test support structure having a first rectangular shaped base in a forward portion of the said test support structure and a second rectangular shaped base in a rear portion of said test support structure;
(b) providing a pair of vertically orientated support cradles for each of said first and second rectangular shaped bases which are located near the front and rear end of said first and second rectangular shaped bases, wherein two sections of said carbon-steel pipe of said noise attenuation device rest on the support cradles of said first and second rectangular shaped bases and the two sections of said carbon-steel pipe; and
(c) providing a front and back joining flange located with said carbon-steel pipe which attaches the two sections of said carbon-steel pipe are attached to each other;
(d) providing a pair of clamping devices for each of said support cradles which secure said carbon-steel pipe to each support cradle of said first and second rectangular shaped bases; and
(e) providing a pair of angled support members, angled at approximately forty five degrees for each of said support cradles, to insure stability of said cradles during the static testing of said jet engine.

20. The method of claim 16 wherein said blockage device for said noise attenuation device comprises a grill end piece attached to the rear end of said carbon steel pipe, said grill end piece operating to limit jet engine exhaust flow through the rear end of said carbon steel pipe when said noise attenuation device is positioned within said jet engine test cell, said grill end piece including a plurality of equally spaced apart horizontal grill members, a plurality of equally spaced apart vertical grill members and a ring structure which is attached to the rear end of said carbon steel pipe, wherein said ring structure has the horizontal grill members and the vertical grill members attached to said ring structure and provides support for said horizontal grill members and said vertical grill members, said horizontal grill members and said vertical grill members being interlaced with one another.
